(19) United States
(12) Patent Application Publication
(10) Pub. No.: US 2008/0169058 A1
(43) Pub. Date: Jul. 17, 2008

(54) Artificial Leather with Color Layers and Method for Making The Same

(76) Inventors: Chung-Chih Feng, Sanmin (TW); Pai-Hsiang Wu, Sanmin (TW); Yuan-Fang Tsai, Fengshan (TW); Jung-Hsien Cheng, Renwu Shiang (TW); Cheng-Ming Lin, Ziguan Shiang (TW); Chien-Chia Huang, Gushan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/733,366

(22) Filed: Apr. 10, 2007

(30) Foreign Application Priority Data
Jan. 11, 2007 (TW) 096101148

(51) Int. Cl. B32B 27/12; B32B 27/20; D06N 3/18

(52) U.S. Cl. 156/246; 428/151; 503/204; 428/411.1; 442/286; 442/394

(57) ABSTRACT

A method is provided for making artificial leather upside down. In the method, an upper color layer is provided on releasing paper and the upper color layer is dried. A lower color layer is provided on the upper color layer and the lower color layer is dried. A paste layer is provided on the lower color layer and the pate layer is preliminarily dried. A substrate is attached to the paste layer. The paste layer is dried. The releasing paper is removed.

### BACKGROUND OF INVENTION

1. Field of Invention

The method invention relates to artificial leather with color layers and a method for making the same.

2. Related Prior Art

A lot of artificial leather has been used in sports gear (such as balls and sneakers), fashion (such as garments, shoes and purses) and furniture (such as sofa, tablecloth and pads) and the like. The superficial effect of the artificial leather is often an important appeal to customers.

Referring to FIG. 1, conventional artificial leather 1 includes a substrate 11, a middle layer 12 on the substrate 11 and a superficial layer 13 on the middle layer 12. The substrate 11 is generally made by submerging non-woven cloth, woven cloth or ultra-fine fiber sub-product in polyurethane (“PU”) resin. The middle layer 12 is generally a foam layer with open cells. The superficial layer 13 includes at least one PU resin layer. A texture 14 is often provided on the superficial layer 13 by grinding, pressing or transferring from releasing paper with a texture.

Referring to FIG. 2, to improve the aesthetic effect of the artificial leather 1, a color layer 15 is provided on the superficial layer 13 generally by floating coating. That is, colorant is blended in resin and the mixture is coated on the superficial layer 13. The color layer 15 exhibits at least one color. If the superficial layer 13 is made of resin mixed with pearl pigment, the use of the color layer 15 with the superficial layer 13 will exhibit a glistening and colorful aesthetic effect.

However, the floating coating of the color layer 15 entails a problem that the glistening and colorful aesthetic effect is uneven since the thickness of the color layer 15 is uneven because the thickness of the artificial layer 1 is uneven. The thickness of the artificial leather 1 is uneven for several reasons. The thickness of the substrate 11 is uneven after it goes through a wet process including the steps of submerging, curing, washing and drying. The unevenness of the thickness of the artificial leather 1 is made worse because of the coating of the middle layer 12 and the superficial layer 13 and the pressing of the superficial layer 13.

Where the superficial layer 13 and the texture 14 are formed by the releasing paper, the floating coating of the color layer 15 will jeopardize the aesthetic effect provided by the releasing paper. This is because the color layer 15 buries the texture 14 that is intended to scatter light and provide a misty effect.

The present invention is therefore intended to obviate or at least alleviate the problems encountered in prior art.

### SUMMARY OF INVENTION

It is an objective of the present invention to provide a simple method for providing artificial leather with color layers.

The foregoing objective is achieved by a method including the steps of providing an upper color layer on releasing paper, drying the upper color layer, providing a lower color layer on the upper color layer, drying the lower color layer, providing a paste layer on the lower color layer, preliminarily drying the pate layer, attaching a substrate to the paste layer, drying the paste layer and removing the releasing paper.

It is another objective of the present invention to provide glistening and colorful artificial leather with color layers.

The foregoing objective is achieved by artificial leather including a substrate, a lower color layer on the substrate and an upper color layer on the lower color layer. The upper and lower color layers are simultaneously transferred to the substrate from releasing paper.

Other objectives, advantages and features of the present invention will become apparent from the following description referring to the attached drawings.

### BRIEF DESCRIPTION OF DRAWINGS

The present invention will be described through detailed illustration of the preferred embodiment referring to the drawings.

FIG. 1 is a cross-sectional view of a conventional type of artificial leather.

FIG. 2 is a cross-sectional view of another conventional type of artificial leather.

FIG. 3 is a cross-sectional view of artificial leather according to the preferred embodiment of the present invention.

FIG. 4 is an enlarged partial view of the artificial leather of FIG. 3.

FIG. 5 is a flowchart of a method for making the artificial leather shown in FIG. 3.

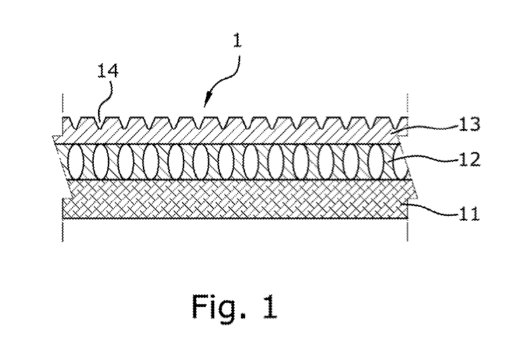

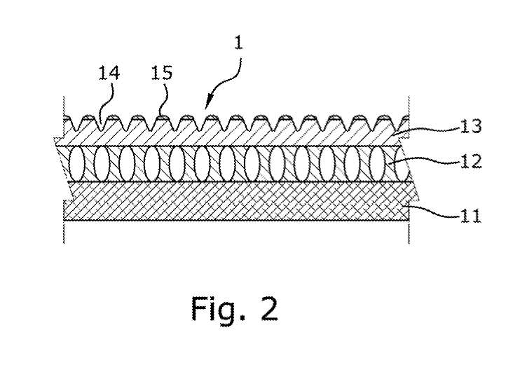

### DETAILED DESCRIPTION OF PREFERRED EMBODIMENT

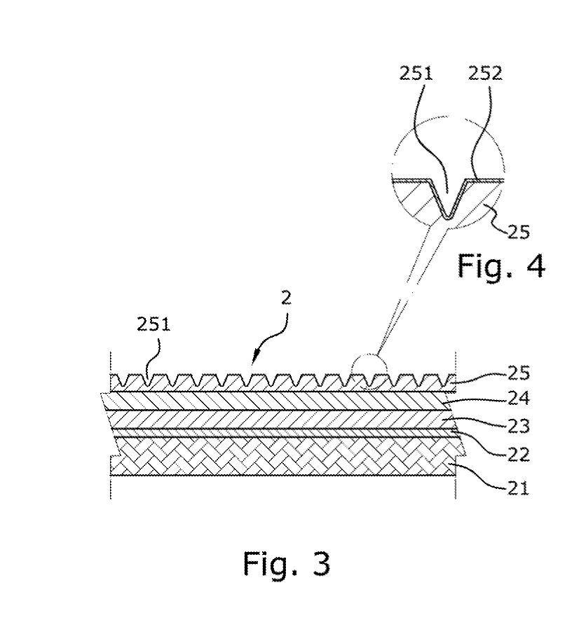

Referring to FIGS. 3 and 4, according to the preferred embodiment of the present invention, artificial leather 2 includes a substrate 21, a paste layer 22 on the substrate 21, a lower color layer 23 on the paste layer 22, a middle color layer 24 on the lower color layer 23 and an upper color layer 25 on the middle color layer 24. A texture 251 is made on the upper color layer 25. A film 252 is provided on the upper color layer 25. It should be noted that the thickness of the various layers is given only for illustrative purposes and not proportionately.

The substrate 21 is preferably non-woven cloth made of ultra-fine fibers submerged in elastomer resin solution in a wet process. The substrate 21 may however be non-woven cloth made by submerging ordinary fibers alone or in combination with ultra-fine fibers in elastomer resin solution in a wet process in other embodiments.

The paste layer 22 is preferably made of two-solution PU resin.

The lower color layer 23 is preferably made by blending pearl pigment powder in one-solution PU resin.

The middle color layer 24 is preferably made by blending colorant powder in one-solution PU resin.

The upper color layer 25 is preferably made by blending colorant in PU resin. The texture 251 is transferred to the upper color layer 25 from releasing paper. The color of the upper color layer 25 is preferably different from that of the middle color layer 24. These colors would better be colors in sharp contrast.

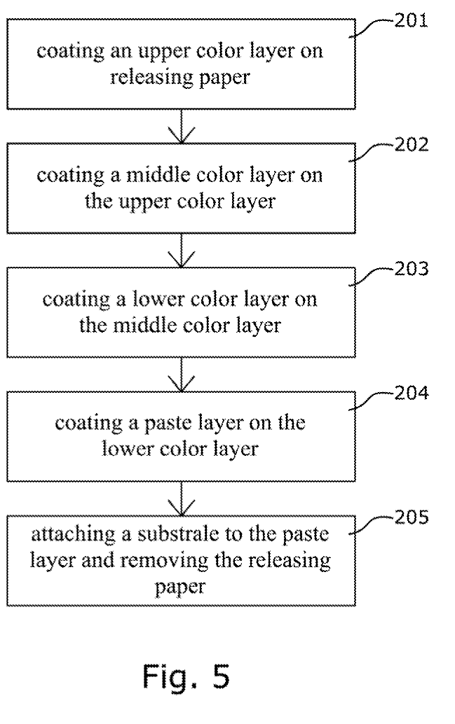

Referring to FIG. 5, there is shown a method for making the artificial leather 2 shown in FIG. 3. It should be noted that the artificial leather 2 is located upside down during the method. The method includes steps 201 through 205.

At step 201, the upper color layer 25, which contains the colorant, is coated on the releasing paper and dried. The upper color layer 25 is made by blending colorant in resin. The resin may be polyurethane, polyvinyl chloride, polycarbonate or expoxy resin for example. The colorant may be pigment, dye or pearl pigment for example.

At step 202, the middle color layer 24, which contains the colorant powder, is coated on the upper color layer 25 and dried.

Ate step 203, the lower color layer 23, which contains the pearl pigment powder, is coated on the middle color layer 24 and dried. The lower color layer 23 is provided by blending colorant in resin. The resin may be polyurethane, polyvinyl chloride, polycarbonate or expoxy resin. The colorant may be pigment, dye and pearl pigment.

At step 204, the paste layer 22 is coated on the lower color layer 23 and dried.

At step 205, the substrate 21 is attached to the paste layer 22 before the releasing paper is removed. Thus, the glistening and colorful artificial leather 2 is made.

More details will be given of the method illustrated in FIG. 5. At step 201, the releasing paper is coated with the film 252 before the upper color layer 25 is coated on the releasing paper. The upper color layer 25 may be coated on the releasing paper by spraying and dried at 120 degrees Celsius.

At step 202, the colorant powder is blended in the one-solution PU resin at a ratio of 0.5% to 10%. The mixture is coated on the upper color layer 24 at a quantity of 150 g/m². The coating is dried at 120 degrees Celsius. Thus, the middle color layer 24 is made.

At step 203, the pearl pigment powder is blended in the one-solution PU resin at a ratio of 0.1% to 10%. The mixture is coated on the middle color layer 24 at a quantity of 150 g/m². The coating is dried at 120 degrees Celsius. Thus, the lower color layer 23 is made.

At step 204, two-solution PU adhesive is coated on the lower color layer 23 at a quantity of 150 g/m². The coating is dried at 70 degrees Celsius. Thus, the paste layer 22 is made.

Ate step 205, the paste layer 22 is attached to the substrate 21 made by submerging ordinary fibers in PU resin in a wet process at a rate of 15 m/min. After curing, the releasing paper is removed from the upper color layer 25 so that the film 252 is transferred from the former to the latter. Thus, the glistening and colorful artificial leather 2 is made.

The artificial leather 2 according to the present invention exhibits several features. Firstly, the upper color layer 25 is provided on the releasing paper that is laid on a flat surface. Thus, the thickness of the upper color layer 25 is even. Therefore, the hue of the color of the upper color layer 25 is even. Secondly, the film 252 is kept intact on the upper color layer 25 so that a misty effect that the releasing paper is intended to provide is shown.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

1. A method for making artificial leather upside down comprising the steps of:
providing releasing paper;
providing an upper color layer on the releasing paper;
drying the upper color layer;
providing a lower color layer on the upper color layer;
drying the lower color layer;
providing a paste layer on the lower color layer;
preliminarily drying the pate layer;
attaching a substrate to the paste layer;
drying the paste layer; and
removing the releasing paper. (claim 1 in Chinese)

2. The method according to claim 1 wherein the upper color layer is provided on the releasing paper by one of spraying, printing, transferring and coating. (claim 2 in Chinese)

3. The method according to claim 1 wherein the step of providing the upper color layer comprises the steps of:
providing resin;
providing colorant; and
blending the colorant in the resin. (claim 1 in Chinese)

4. The method according to claim 3 wherein the resin is selected from a group consisting of polyurethane, polyvinyl chloride, polycarbonate and expoxy resin. (claim 3 in Chinese)

5. The method according to claim 3 wherein the colorant is selected from a group consisting of pigment, dye and pearl pigment. (claim 3 in Chinese)

6. The method according to claim 1 wherein the lower color layer is provided on the upper color layer by one of spraying, printing, transferring and coating. (claim 5 in Chinese)

7. The method according to claim 1 wherein the step of providing the lower color layer comprises the steps of:
providing resin;
providing colorant; and
blending the colorant in the resin. (claim 4 in Chinese)

8. The method according to claim 7 wherein the resin is selected from a group consisting of polyurethane, polyvinyl chloride, polycarbonate and epoxy resin. (claim 6 in Chinese)

9. The method according to claim 7 wherein the colorant is selected from a group consisting of pigment, dye and pearl pigment. (claim 6 in Chinese)

10. The method according to claim 1 comprising the step of providing a middle color layer between the upper and lower color layers. (claim 4 in Chinese)

11. The method according to claim 10 wherein the step of providing the middle color layer comprises the steps:
providing resin;
providing pearl pigment; and
blending the pearl pigment in the resin. (claim 4 in Chinese)

12. Artificial leather comprising:
a substrate;
a lower color layer provided on the substrate; and
an upper color layer provided on the lower color layer wherein the upper and lower color layers are simultaneously transferred to the substrate from releasing paper. (claim 8 in Chinese)

13. The artificial leather according to claim 12 wherein the substrate is selected from a group consisting of woven cloth and non-woven cloth. (claim 9 in Chinese)

14. The artificial leather according to claim 12 comprising a middle color layer between the bottom and upper color layers. (claim 10 in Chinese)

15. The artificial leather according to claim 14 wherein the lower color layer comprises colorant. (claim 10 in Chinese)

16. The artificial leather according to claim 14 wherein the middle color layer comprises pearl pigment powder. (claim 10 in Chinese)

17. The artificial leather according to claim 14 wherein the lower color layer comprises resin and colorant blended in the resin. (claim 11 in Chinese)

18. The artificial leather according to claim 17 wherein the colorant is selected from a group consisting of pigment and pearl pigment. (claim 11 in Chinese)

19. The artificial leather according to claim 14 wherein the upper color layer comprises resin and colorant blended in the resin. (claim 12 in Chinese)

20. The artificial leather according to claim 12 wherein the upper color layer comprises a color and a misty surface transferred from the releasing paper. (claim 12 in Chinese)
